(19) United States
(12) Patent Application Publication
(10) Pub. No.: US 2004/0002977 A1
(43) Pub. Date: Jan. 1, 2004

(54) Method and system for veryfing a deed

(76) Inventors: Hideki Tokuyama, Sagamihara (JP); Katsuya Yokomura, Yokohama (JP); Takao Yoden, Saitama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/289,294

(22) Filed: Nov. 7, 2002

(30) Foreign Application Priority Data
Nov. 7, 2001 (JP) 2001-341362

(51) Int. Cl. G06F 7/00

(52) U.S. Cl. 707/9

(57) ABSTRACT

A small-sized ID chip is attached onto an article, which may be imitated or counterfeited, such as an identify certificate and/or valuable securities, etc., for example. From the small-sized ID chip can be read out an ID through a readout device for exclusive use thereof, and is provided means for memorizing the ID of the small-sized ID chip in relation to information described on a certificate or the like, wherein the ID is read out from the small-sized ID chip attached thereon with using the readout device for exclusive use thereof, thereby to be compared with, by referring to the information in relation to that ID, when determination is made upon verification of the identify certificate, for example.

### BACKGROUND OF THE INVENTION

The present invention relates to a method and a system, for verifying a deed, including valuable securities and an identify card, etc., as well as, paper money, such as a bill or note, on validity and justifiability thereof. And, the present invention relates to a method and a system, for conducting dealing of the valuable securities, which necessitates identification thereupon.

For conducting dealing of the valuable securities or the like, it is necessary to check on whether a person bringing them in be actually the person her/himself or not, who has a right or authority of using or handling of those securities.

As to traveler's checks, for example, a user thereof, in general, visits a clerk at the window thereof, being located, such as in a bank, etc., thereby to purchase the traveler's checks, and then she/he makes her/his own signature in a column or section for the owner thereof. Thereafter, the user exchanges the checks to money or bills, visiting at a window handling therewith. The procedure in this instance is as follows: i.e., the user makes the signature (or, a counter signature) in the column or section being different from that, in which she/he already made the signature when buying the traveler's checks, and thereby she/he can receive the cash money after completion of the identification of her/himself by submission or showing of an identify card or the like of her/himself, such as a passport, for example.

However, such the personal identification is conducted through a visual check or observation by human eyes, and therefore it cannot say that a sufficient countermeasure is taken to prevent such the certificate from counterfeiting thereof. On such the identification evidence, such as the passport, etc., the countermeasure is taken to prevent from the counterfeiting, through a special printing technology. However, robbery of the passport, and the counterfeiting through replacing the picture and/or rewriting of the information described thereon are still of the problems. Also, in particular, with the valuable securities, there is a problem of being counterfeited through an easy copy thereof, with an improvement of the printing technology.

### SUMMARY OF THE INVENTION

An object, according to the present invention, is to provide a deed verifying method and a system thereof, for protecting the deed and the paper money, etc., from imitation or counterfeit thereof, thereby improving security in dealing thereof.

According to the present invention, for accomplishing the above objects, a small-sized ID chip is attached on the valuable securities and/or an identify certificate, etc., an ID of which can be read out by a readout device (a terminal device), while a means is provided for storing the information of the valuable securities, such as contacting conditions or contents, etc., as well as the information of the small-sized chip attached on the valuable securities, in connection with each other, and further a means for storing the information of the identify certificate and the information of the small-sized chip attached on the identify certificate, in connection with each other.

A person who wishes to buy the valuable securities, which necessitates the identify certificate, shows the identify certificate when she/he tries to the valuable securities, thereby registering it as a part of the contracting contents of valuable securities. The person who bought the valuable securities carries those valuable securities with and shows the identify certificate of her/his own, when dealing the valuable securities, while at a window handling the valuable securities, the valuable securities and the identify certificate are confirmed to be the authentic ones or not, by referring to the ID information of the small-sized ID chip and the information in relation thereto, thereby to conduct the dealing thereof.

According to the present invention, also a memory medium, being attached onto the deed for achieving a predetermined function, memorizes an identification information therein, while a computer (a center), for carrying out information processing in accordance with a program, memorizes said identification information and a deed information relating to the said deed, wherein a terminal device connected to said computer reads out said identification information stored in said memory medium, and the said computer receives said identification information read out, so as to search out the deed information corresponding to said identification information received, thereby enabling determination in relation to validity of said deed upon the basis of said deed information searched out and the contents mentioned on said deed.

In this instance, the terminal device may be constructed to receive said deed information searched out, thereby making display of said deed information received. The user may compare the displayed contents to those described on the deed, thereby determining the validity thereof.

Also, the terminal device may be constructed to receive said deed information searched out, while reading out the contents described on said deed by means of a readout machine, thereby making determination on the validity of said deed, upon the basis of said deed information received and the described contents read out.

Further, it is also possible to make determination on validity of said deed, if they are coincident with each other at least a predetermined part thereof, in comparison between said deed information received and the described contents read out.

### BRIEF DESCRIPTION OF THE DRAWINGS

FIG. 1 is a view for showing the system configuration of an embodiment according to the present invention;

FIG. 2 is view for showing the data structure in a memory device 1014 within an ID management server, in the embodiment according to the present invention;

FIG. 3 is a view for showing the data structure of a memory device 1033 of an identify certificate management server 1003, in the embodiment according to the present invention;

FIG. 4 is a view for showing the data structure of a memory device 1043 of a valuable security management server 1004, in the embodiment according to the present invention; and

FIG. 5 shows a flowchart for showing processing in the embodiment according to the present invention.

### DETAILED DESCRIPTION OF THE PREFERRED EMBODIMENTS OF THE INVENTION

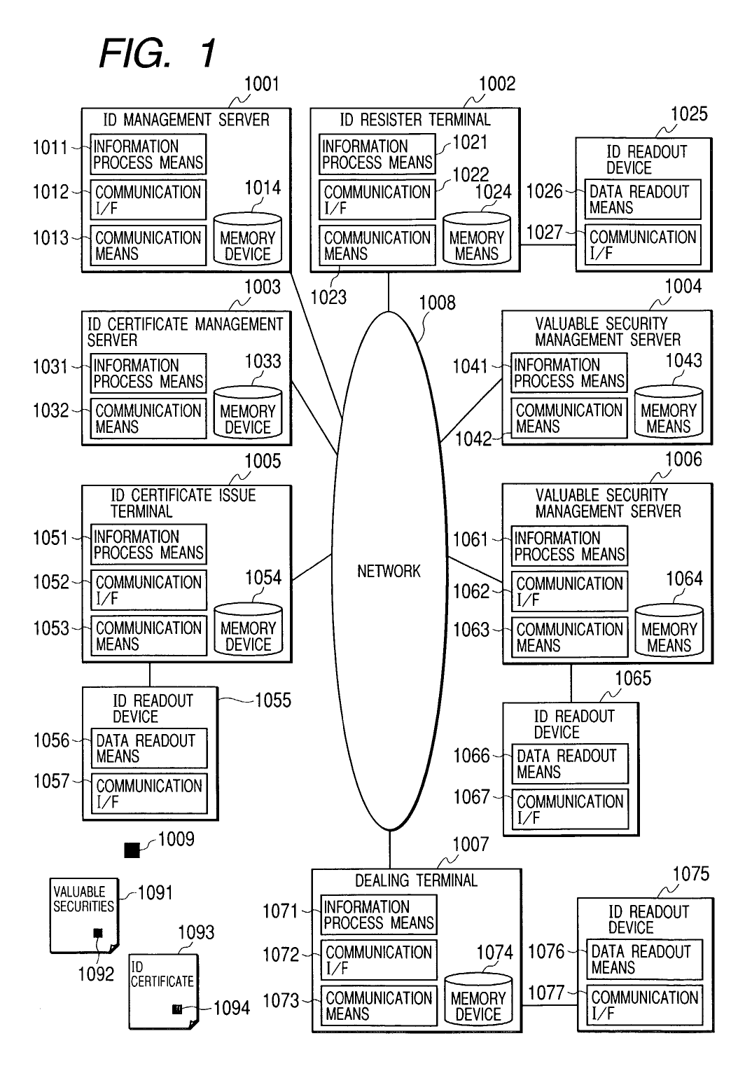

FIG. 1 shows the system configuration, according to the present invention, wherein through a network 1008 are connected an ID management center 1001 for supervising or managing IDs of small-sized ID chips 1009, 1092 and 1094, an ID register terminal 1002 for registering therein the Ids of the small-sized ID chips 1009, 1092 and 1094, an identify certificate management server 1003 for managing the identify certificates therein, a valuable security management server 1004 for managing the valuable securities therein, an identify certificate issuing terminal 1005 for issuing the identify card or certificate to a user, a valuable security issuing terminal 1006 for issuing the valuable securities to the user, and a dealing terminal 1007 for conducting handling or dealing of the identify certificate and the valuable securities therethrough. Also, to the ID register terminal 1002, the identify certificate issuing terminal 1005, and the valuable security dealing terminal 107 are connected an ID readout device 1025, an ID readout device 1055, an ID readout device 1065 and an ID readout device 1075, respectively. Into the small-sized ID chips 1009, 1092 and 1094 are written IDs, being specific or unique for each, respectively. It is preferable that the IDS of the small-sized ID chips 1009, 1092 and 1094 are different from one another. Those IDs can be read out by using ID readout devices 1205, 1055, 1065 and 1075, etc. The small-sized ID chip 1092, into which is written the ID being different from that of the small-sized chip 1009, is attached onto an valuable securities 1091, while the small-sized ID chip 1094 onto the identify certificate 1093. For the small-sized ID chip 1092 attached onto the valuable securities 1091, it is preferable to be formed with the valuable security 1091 in one body, inseparably, and also for the small-sized ID chip 1094 attached onto the identify certificate 1093, it is preferable to be formed with the identify certificate 1093 in one body, inseparably. Further, as is described in the U.S. patent application Ser. No. 09/856,758, it is preferable that those small-sized ID chips 1092 and 1094 are buried within the valuable securities 1091 and/or the identify certificate 1093, so as not to be broken. And, it is also preferable that those small-sized ID chips 1092 and 1094 are buried within the valuable securities 1091 and/or the identify certificate 1093, so as not to be seen from an outside by human eyes. Each of those small-sized ID chips 1092 and 1094 is, preferably, a semiconductor memory medium, for example, having a size of about 5 mm.

Next, the operation of the system according to the present invention will be explained briefly.

First, explanation will be given on steps of an initial registration process. A manufacturer or an issuer of the small-sized ID chips 1009, 1092, and 1094 gives serial IDs to those small-sized ID chips 1009, 1092, and 1094, respectively. The ID readout device 1025 reads out the chip IDs of the manufactured small-sized ID chips 1009, 1092, and 1094, and it transmits information, such as the chip ID, etc., (for example, a readout device ID) to the ID register terminal 1002. Upon receipt of this information, the ID register terminal 1002 adds information (for example, registration date, delivery destination information, an object for use, conditions, etc.) to the information received from the ID readout device 1025, thereby transmitting them through the network 1008 to the ID management server 1001. The ID management server 1001 memorizes the information received from the ID registrar terminal 1002 into the memory device 1014 thereof. The information to be added may be inputted into the ID readout device 1025 by a person who makes an initial registration, or may be automatically read into with using a scanner or the like, in the ID readout device 1025.

Next, explanation will be given on steps of issuing process of the certify certificate. A person who requests the issue of the identify certificate writes down information necessary for identification, such as, the address, the name, the date of her/his birth, etc., for example, on an application paper thereof, and then the issuer issues the identify certification 1093 attached with the small-sized ID chip 1094. When handing over the identify certificate to her/him, the issuer makes check or verify identification of the person her/himself who requests the issue thereof, and instructs the readout onto the ID readout device 1055 when completing the identification. Upon receipt of the instruction, the ID readout device 1055 reads out the information (for example, the chip ID) of the small-sized ID chip 1094. The ID readout device 1055 transmits this information (for example, the chip ID and the readout device ID) to the identify certificate issuing terminal 1005. Upon receipt of this information, the identify certificate issuing terminal 1005 transmits the information through the network 1008 to the identify certificate management server 1003, adding with the information described on the identify certificate 1093 (for example, registration date, effective term or period, lapse date, lapse reason, renewal information, conditions, etc.) there to, and then the identify certificate management server 1003 memorizes the information received into the memory device 1033 thereof. The information to be added may be inputted into the ID readout device 1055 by the issuer, or may be automatically read into the ID readout device 1055.

Next, explanation will be given on steps of issuing process of the valuable securities, which needs the identify certificate upon dealing thereof. A person who wishes to purchase or buy the valuable security visits at the place issuing the valuable securities, carrying the identify certificate with her/him, and shows the identify certificate when she/he tries to buy the valuable security necessitating the identify certificate thereupon. Herein, the information (for example, the chip ID) of the small-sized ID chip 1092 attached onto the valuable security is read out by means of the ID readout device 1065, to be transmitted to the valuable security issuing terminal 1006. Upon receipt of this, the valuable security issuing terminal 1006 adds information necessary for the valuable securities (for example, valuable security information, registration date, registrant information, personal information, effective date, lapse date, lapse reason, renewal information, conditions, etc.). Herein, preferably, the ID readout device 1065 reads out the information of this small-sized ID chip 1094, when the small-sized ID chip 1094 is attached onto the identify certificate that is submitted by the person who purchases the valuable security, thereby transmitting the information read out to the valuable security issuing terminal 1006. The valuable security issuing terminal 1006 adds this information to that of the identify certificate mentioned above, thereby sending those to the valuable security management server 1004 through the network 1008, as the information of the valuable securities. Upon receipt of this information, the valuable security management server 1004 memorizes the information received into the memory device 1043 thereof.

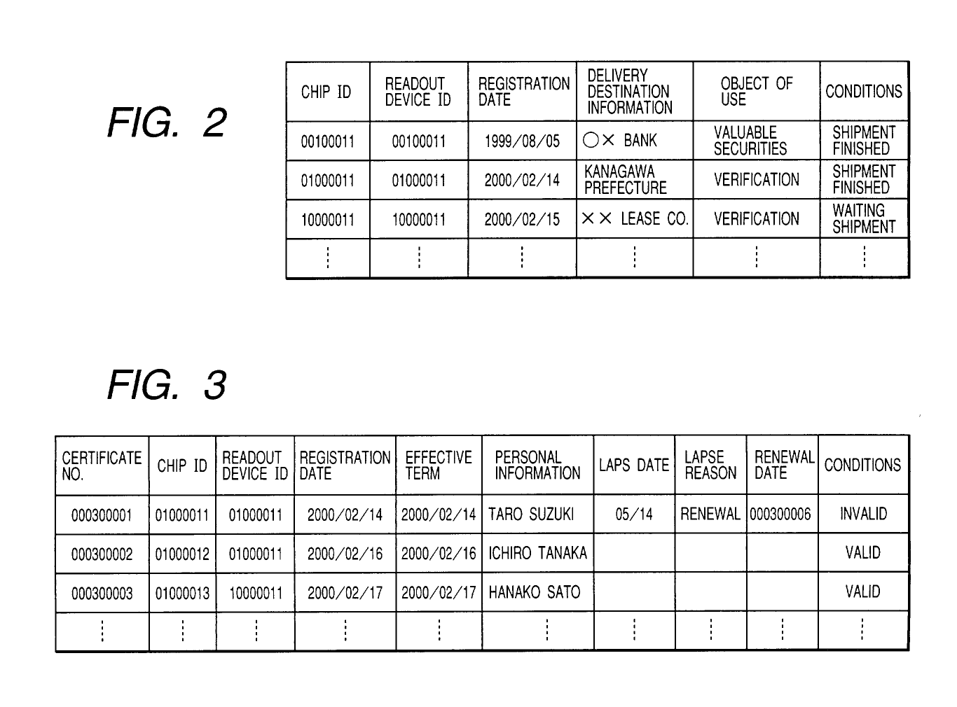

FIG. 2 shows an example of detailed information memorized in the memory device 1014 within the ID management server shown in FIG. 1 mentioned above. This information includes the chip IDs for discriminating the small-sized ID chips 1009, 1092 and 1094, the readout device IDs for discriminating the ID readout devices that reads out the chip IDs, the registration date (year/month/day) for specify the date of registration, the delivery destination information indicative of the delivery destination, information indicative of the object of use and/or a subject on which the small-sized ID chip is attached, information of the conditions of delivery, and so on. Since from the information are apparent the registration date (year/month/day), the delivery destination and the object of use, etc., of the small-sized ID chips 1009, 1092 and 1094, the fact can be clear that the chip is illegally imitated or counterfeited if the small-sized chips 1009, 1092 or 1094 is used for the other purposes outside of the inherent object thereof, or if the chip ID of the small-sized ID chip 1009, 1092 or 1094 is not registered. And it is clear that the valuable securities 1092 or the identify certificate 1093 is illegally imitated or counterfeited, if the valuable securities 1092 or the identify certificate 1093 is not attached with that small-sized ID chip 1092 or 1094, which should be attached with that small-sized ID chip 1092 or 1094 inherently.

FIG. 3 shows an example of the detailed information memorized in the memory device 1033 of the identify certificate management server 1003 shown in FIG. 1 mentioned above. This information includes an identify certificate number (including the identify certificate ID) for managing the identify certificate, the chip ID of the small-sized ID chip 1094 attached onto the identify certificate, the readout device ID for discriminating the ID readout device, through which the chip ID is read out, the registration date (year/month/day) of the identify certificate, the effective term or period of the identify certificate, personal information (the personal information of the owner of the identify certificate), the date (year/month/day) of lapse for elapsing the identify certificate, a reason of lapse of the identify certificate, renewal information if the identify certificate is renewed, a condition of the identify certificate (valid or invalid), etc. This personal information includes ones described on the identify certificate, such as, the name, the date (year/month/day) of birth, sex, the legal domicile, an image of the picture for identification, etc., for example. The identify certificate management server 1003 obtains this information from the chip ID of the small-sized ID chip, which is attached on the identify certificate, so as to compare it with the information described on the identify certificate, thereby enabling to confirm that the identify certificate is not imitated or counterfeited on a front surface of the identify certificate is described (or displayed) at least one of the identify certificate number, the registration date (year/month/day), the effective term or period, the personal information of the person to be identified, the date (year/month/day) of lapse, the reason of lapse, and the renewal information.

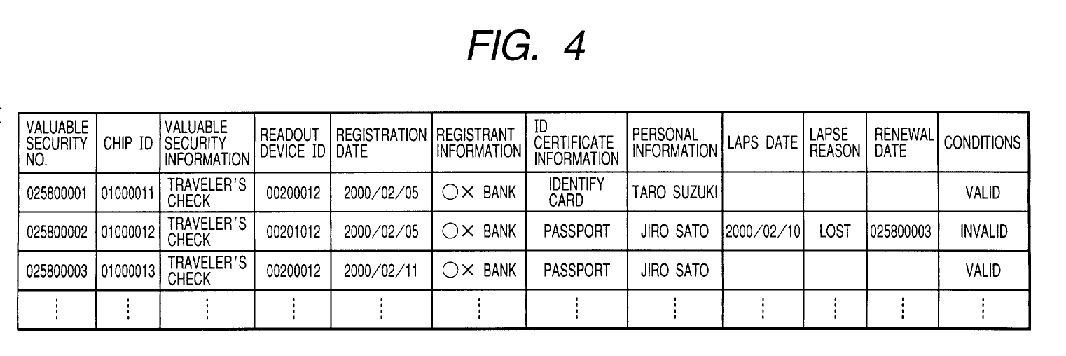

FIG. 4 shows an example of the detailed information memorized in the memory device 1043 of the valuable security management server 1004 shown in FIG. 1 mentioned above. This information includes a valuable security number (including a valuable security ID) for managing the valuable securities, the chip ID of the small-sized ID chip 1092, which is attached on the valuable securities, valuable security information for showing a sort or kind of the valuable securities, the readout device ID for discriminating the ID readout device, through which the chip ID is readout, date (year/month/day) of registration of the valuable securities, information about a registration organization which registers the valuable securities, an identify certificate information indicative of a kind of the identify certificate, being carried by a person who requests issue of the valuable securities, personal information described or mentioned when an application is made for the valuable securities (the personal information of the owner of the valuable securities), the lapse date (year/month/day) of the valuable securities, the lapse reason of the valuable securities, the renewal date (year/month/day) of the valuable securities, the conditions of the valuable securities (valid or invalid), etc. On a front surface of the valuable securities is described (or displayed) at least one of the valuable security number, the valuable security information, registration the date (year/month/day), the information about the registration organization, the identify certificate information, the personal information, the lapse date (year/month/day), the lapse reason, and the renewal date (year/month/day).

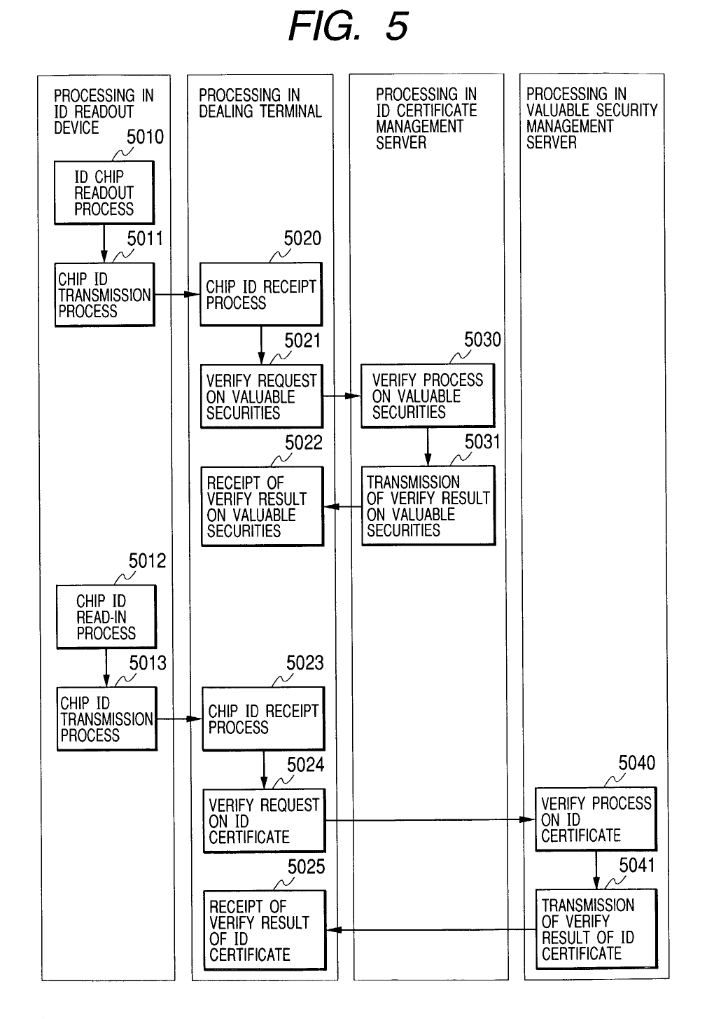

FIG. 5 shows an example of steps of dealing with the valuable securities, according to the present invention. Fist, the ID readout device 1075 reads out the ID of the small-sized ID chip 1092, which is attached on the valuable securities 1091, in a step of chip ID readout process 5010. Next, in a step of chip ID readout process 5011, the ID readout device 1075 transmits the chip ID of the small-sized ID chip 1092, which was read out in advance, to the dealing terminal 1007. The dealing terminal 1007 receives the chip ID in a step of chip ID receiving process 5020, and in a step of valuable security verification request 5021, it transmits a request for determining authenticity on the valuable securities, including the information, such as the chip ID received in the chip ID receiving process 5020, for example, through the network 1008 to the valuable security management server 1004. Upon receipt of the request for determining the authenticity, the valuable security management server 1004 carries out a verification process in a step of valuable security verification process 5030. In this verification process, the verification is made on whether the chip ID received is memorized in the memory device 1043 or not, and/or on whether the relative data of the chip ID is valid or invalid, etc. When the verification is succeeded in this valuable security verification process 5030, a result of the verification and relative information thereof are transmitted through the network 1008 to the dealing terminal 1007, in a step of valuable security verification result transmission 5031. Upon receipt of this result of the verification and the relative information, the dealing terminal 1007 shows the verification and the relative information on a display screen of the dealing terminal 1007. Herein, if failing in the verification, it means that the small-sized ID chip is the imitation or counterfeit. It is preferable that the dealing terminal displays an effect of failure in verification and/or an effect that the valuable securities are counterfeits, on the display screen of the dealing terminal. And, in a case when succeeding on the verification thereof, but if the relative information displayed is different from the valuable securities 1091 in the contents described thereon, it means the fact that a kind of counterfeiting was made, such as a conversion or refunding, etc. The comparison between the relative information and the contents mentioned or described on the valuable securities 1091 may be made by a dealer of the valuable securities, or may be made by means of the valuable security issuing terminal 1006. In a case when this will be done by the dealing terminal 1007, it is preferable to read out the contents described on the valuable securities 1091 from the surface thereof, with using a scanner or the like, in the dealing terminal 1007 and/or the ID readout device 1075 thereof. Upon success on the verification of the valuable securities, if no error can be found in the relative information (i.e., when the relative information displayed is coincident with the contents described on the valuable securities 1091), further verification will be made, but on identification, continuously.

First, the ID readout device 1075 reads out the ID of the small-sized ID chip 1094 attached on the identify certificate 1093 in a step of chip ID readout process 5012. Next, in a step of chip ID transmission process 5013, the ID readout device 1075 transmits the chip ID of the small-sized ID chip 1094, which was read out in advance, to the dealing terminal 1007. Upon receipt of the chip ID in a step of chip ID receiving process 5023, the dealing terminal 1007 transmits a request for determining authenticity on the identify certificate, including the information, such as the chip ID received in the chip ID receiving process 5023, for example, through the network 1008 to the identify certificate management server 1003, in a step of identify certificate request process 5024. Receiving the request for determining authenticity, the identify certificate management server 1003 carries out a verification process in a step of identify certificate verifying process 5040. In this verification process, verification is made on whether the chip ID received is memorized or not in the memory device 1033, and/or on whether the relative data of the chip ID is valid or not, etc. In a case when the verification is succeeded in this identify certificate verifying process 5040, a verification result and the relative information thereof are transmitted through the network 1008 to the dealing terminal 1007 in a step of identify certificate verification result transmission 5041. Receiving this verification result and the relative information thereof, the dealing terminal 1007 displays the verification result and the relative information. Herein, if failing in the verification, it means that the small-sized ID chip is the imitation or counterfeit. Also, in the case when the verification is succeeded, but if the relative information displayed differs from the identify certificate 1093 in the contents described thereon, it means the fact that a kind of counterfeiting was made, such as a conversion or refunding, etc. The comparison between the relative information and the contents described on the identify certificate 1093 may be made by the dealer of the valuable securities, or may be made by the dealing terminal 1007. In a case when this will be done by the dealing terminal 1007, it is preferable to read out the contents described on the identify certificate 1093 from the surface thereof, with using a scanner or the like, in the dealing terminal 1007 and/or the ID readout device 1075 thereof.

After making confirmation that the valuable securities and the identify certificate are authentic ones, in the manner mentioned above, and further after confirming that the person described on the identify certificate is the same one who carries the valuable securities, the dealing terminal 1007 starts dealing thereof. It is also possible that the dealing terminal 1007 displays the effect that the dealing is allowed.

According to the embodiment of the present invention, attachment of the small-sized ID chip on the identify certificate, being readable by means of the readout device for exclusive use thereof, enables to protect the identify certificate from the imitation or counterfeit thereof. In the same manner, attachment of the small-sized ID chip on the valuable securities, being readable by means of the readout device for exclusive use thereof, enables to protect the valuable securities from the imitation or counterfeit thereof. Moreover, the enabled protection of the identify certificate and the valuable securities from the imitation or counterfeit thereof, further makes possible the dealing of valuable securities with safety.

What is claimed is:

1. A method for verifying a deed, comprising the following steps of:
memorizing an ID in a memory medium to be attached onto the deed for achieving a predetermined function therewith;
memorizing said ID and a deed information relating to said deed by means of a computer for executing information processing in accordance with a program;
reading out said ID stored in said memory medium by means of a terminal device being connected with said computer; and
receiving said ID read out by means of said computer, thereby searching the deed information corresponding to said received ID, and making determination on validity of said deed, upon basis of said deed information searched out and contents described on said deed.

2. The deed verifying method, as defined in the claim 1, wherein said terminal device receives said deed information searched out, thereby to display said deed information received.

3. The deed verifying method, as defined in the claim 1, wherein said terminal device receives said deed information searched out, and reads out contents described on said deed through a readout device, thereby making determination on validity of said deed, upon basis of said deed information received and the described contents read out.

4. The deed verifying method, as defined in the claim 3, wherein said deed information received and the described contents read out are compared with, and said deed is determined to be valid if they coincide with each other at least in a predetermined portion thereof.

5. A method for dealing valuable securities, necessitating identification therein, comprising the following steps of:
a fist step for reading out a first medium ID from a first semiconductor memory medium, being unique thereto, which is attached onto said valuable securities, on which is displayed a valuable security number unique thereto;
a second step for transmitting said first medium ID read out to a first management server for managing said valuable security number and a first relative information, including said valuable security number and a condition information of validity or invalidity of said valuable securities therein, in relation to said first medium ID;
a third step for receiving said first relative information from said first management server, when said valuable securities are determined to be valid upon basis of said condition information included in said first relative information by means of said first management server;
a fourth step for reading out a second medium ID from a second semiconductor memory medium, being unique thereto, which is attached onto an identify certificate, on which is displayed a certification number being unique thereto, for certifying to be an owner of said valuable securities, when said valuable security number included in said first relative information received is determined to coincide with said valuable security number displayed on said valuable securities;
a fifth step for transmitting said second medium ID read out to a second management server for managing said identify certificate number and a second relative information, including a condition information of validity or invalidity of said identify certificate therein, in relation to said second medium ID;
a sixth step for receiving said second relative information from said second management server, when said identify certificate is determined to be valid upon basis of said condition information contained in said second relative information by means of said second management server; and
a seventh step for allowing dealing of said valuable securities, when said certificate number included in said second relative information received is determined to coincide with said certificate number displayed on said identify certificate.

6. The method described in the claim 5, further comprising:
an eighth step for displaying said valuable security number included in said received first relative information on a display screen, after said third means; and
a ninth step for displaying said received certificate number included in said second relative information, on said display screen, after said sixth step.

7. The method described in the claim 5, wherein
said first step further includes a step for reading out said valuable security number displayed on said valuable securities;
said third step further includes a step for making a determination on whether said valuable security number included in said first relative information received is coincident or not with said valuable security number displayed on said valuable securities, by comparing said valuable security number included in said first relative information received to said valuable security number read out in said first step;
said fourth step further includes a step for reading out said certificate number displayed on said identify certificate; and
said fifth step further includes a step for making a determination on whether said certificate number included in said second relative information received is coincident or not with said certificate number displayed on said identify certificate, by comparing said certificate number included in said second relative information received to said certificate number read out in said fourth step.

8. The method as described in the claim 5, wherein
said first semiconductor memory medium is in one body with said valuable securities; and
said second semiconductor memory medium is in one body with said identify certificate.

9. The method as described in the claim 5, wherein
said fourth step further includes a step for stopping the dealing of said valuable securities, in a case when said valuable security number included in said first relative information received is determined to differ from said valuable security number displayed on said valuable securities; and
said seventh step further includes a step for stopping the dealing of said valuable securities, in a case when said certificate number included in said second relative information received is determined to differ from said certificate number displayed on said identify certificate.

10. The method as described in the claim 5, wherein
said first relative information includes an identify certificate information indicative of a kind of said identify certificate; and
said fourth step further includes a step for reading out said second medium ID from said second semiconductor memory medium, when the identify certificate shown by the owner of said valuable securities is determined to differ from said identify certificate of said identify certificate information in the kind thereof.

11. The method as described in the claim 5, further including the following steps of:
an eighth step for reading out said first medium ID from said first semiconductor memory medium, thereby transmitting said first medium ID read out and said valuable security number displayed on said valuable securities to said first management server, when issuing said valuable securities; and
a ninth step for reading out said second medium ID from said second semiconductor memory medium, thereby transmitting said second medium ID read out and said certificate number displayed on said identify certificate to said second management server, when issuing said identify certificate.

12. The method as described in the claim 11, further including the following step of:
a tenth step for making management in relation to an object of use of said first semiconductor memory medium or a name of an object, onto which said first semiconductor memory medium is attached, an identification information of a publisher of said valuable securities, and said first medium ID, when issuing said first semiconductor memory medium to the publisher of said valuable securities.

13. The method as described in the claim 11, further including the following step of:
a tenth step for making management in relation to an object of use of said second semiconductor memory medium or a name of an object, onto which said second semiconductor memory medium is attached, an identification information of a publisher of said identify certificate, and said second medium ID, when issuing said second semiconductor memory medium to the publisher of said identify certificate.

14. A system for dealing with valuable securities necessitating identification therein, comprising:
a first means for reading out a first medium ID being unique thereto from a first semiconductor memory medium attached on said valuable securities, on which a valuable security number is attached, being unique to said valuable securities;
a second means for transmitting said first medium ID read out to a first management server for making management in relation to said valuable security number and a first relative information including a condition information of validity or invalidity of said valuable securities therein, with said first medium ID;
a third means for receiving said first relative information from said first management server, in a case when said valuable securities are determined to be valid upon basis of said condition information included in said first relation information, by means of said first management server;
a fourth means for reading out a second medium ID from a second semiconductor memory medium, being unique thereto, which is attached on an identify certificate for certifying to be an owner of said valuable securities, on which is displayed a certificate number being unique to said identify certificate, when said valuable security number included in said first relative information received is determined to coincide with said valuable security number displayed on said valuable securities;
a fifth means for transmitting said second medium ID read out to a second management server for managing said certificate number and a second relative information, including a condition information of validity or invalidity of said identify certificate therein, in relation to said second medium ID;
a sixth means for receiving said second relative information from said second management server, in a case when said identify certificate is determined to be valid upon basis said condition information included in said second relative information by means of aid second management server; and
a seventh means for allowing dealing of said valuable securities, when said certificate number included in said second relative information received is determined to coincide with said certificate number displayed on said identify certificate.

15. The system as described in the claim 14, further including:
an eighth means for displaying said valuable security number included in said received first relative information on a display screen, after said third step; and
a ninth means for displaying said received certificate number included in said second relative information, on said display screen, after said sixth means.

16. The system described in the claim 14, wherein
said first means reads out said valuable security number displayed on said valuable securities;
said third means makes a determination on whether said valuable security number included in said first relative information received is coincident or not with said valuable security number displayed on said valuable securities, by comparing said valuable security number included in said first relative information received to said valuable security number read out by said first means;
said fourth means reads out said certificate number displayed on said identify certificate; and
said fifth means makes a determination on whether said certificate number included in said second relative information received is coincident or not with said certificate number displayed on said identify certificate, by comparing said certificate number included in said second relative information received to said certificate number read out by said fourth means.

17. The system as described in the claim 14, wherein
said first semiconductor memory medium is in one body with said valuable securities; and
said second semiconductor memory medium is in one body with said identify certificate.

18. The system as described in the claim 5, wherein
said fourth means stops the dealing of said valuable securities, in a case when said valuable security number included in said first relative information received is determined to differ from said valuable security number displayed on said valuable securities; and
said seventh means stops the dealing of said valuable securities, in a case when said certificate number included in said second relative information received is determined to differ from said certificate number displayed on said identify certificate.

19. The system as described in the claim 14, wherein
said first relative information includes an identify certificate information indicative of a kind of said identify certificate; and
said fourth means reads out said second medium ID from said second semiconductor memory medium, when the identify certificate shown by the owner of said valuable securities is determined to differ from said identify certificate of said identify certificate information in the kind thereof.

20. The system as described in the claim 14, further including:
an eighth means for reading out said first medium ID from said first semiconductor memory medium, thereby transmitting said first medium ID read out and said valuable security number displayed on said valuable securities to said first management server, when issuing said valuable securities; and
a ninth means for reading out said second medium ID from said second semiconductor memory medium, thereby transmitting said second medium ID read out and said certificate number displayed on said identify certificate to said second management server, when issuing said identify certificate.

21. The system as described in the claim 20, further including:
a tenth means for making management in relation to an object of use of said first semiconductor memory medium or a name of an object, onto which said first semiconductor memory medium is attached, an identification information of a publisher of said valuable securities, and said first medium ID, when issuing said first semiconductor memory medium to the publisher of said valuable securities.

22. The system as described in the claim 20, further including:
a tenth means for making management in relation to an object of use of said second semiconductor memory medium or a name of an object, onto which said second semiconductor memory medium is attached, an identification information of a publisher of said identify certificate, and said second medium ID, when issuing said second semiconductor memory medium to the publisher of said identify certificate.
